(19) United States
(12) Patent Application Publication
(10) Pub. No.: US 2015/0300499 A1
(43) Pub. Date: Oct. 22, 2015

(54) Seal Assembly with Threads

(71) Applicant: Caterpillar Inc., Peoria, IL (US)

(72) Inventor: Jeffrey E. Jensen, Dunlap, IL (US)

(73) Assignee: Caterpillar Inc., Peoria, IL (US)

(21) Appl. No.: 14/255,413

(22) Filed: Apr. 17, 2014

(51) Int. Cl. F16J 15/34; B62D 55/088

(52) U.S. Cl. CPC F16J 15/344; B62D 55/0887

(57) ABSTRACT

A seal assembly is disclosed which may include a seal ring, a load ring in engagement with the seal ring, and a plurality of threads provided in the seal ring and the load ring so as to join the seal ring and the load ring together.

### FIELD OF THE DISCLOSURE

The present disclosure generally relates to seal assemblies and, more particularly, relates to seal assemblies used in association with track or linkage pins of earth moving equipment.

### BACKGROUND OF THE DISCLOSURE

Machines used in earth moving, agricultural and construction applications are subjected to extreme wear. The moving components of such machines need to be provided with a constant supply of lubrication and do so while limiting the loss of that lubrication to the environment and inflow of debris from the worksite into the lubrication supply.

Two examples of such machines are track-type tractors and wheeled loaders. With a track-type tractor, a pair of continuous tracks are provided so as to provide locomotion to the machine. The tracks are trained around a plurality of drive sprockets and idlers with an engine of the machine rotating the drive sprockets. This in turn rotates the track over the sprockets and idlers. The track itself is comprised of a number of individual track shoes connected by track links. The track links are themselves connected through a plurality of bushings and track pins to allow for the track to pliably move around the sprockets and idlers while at the same time ensuring the structural integrity of the track remains in place. In such an embodiment, it can therefore be seen that the supply of lubrication to such track pins is of the utmost importance.

Another example is with respect to the aforementioned wheeled loader. With such a machine, a pair of boom arms are pivotally attached to the machine and are in turned pivotally connected to a bucket or other work implement. Alternatively, a secondary set of arms may be interposed between the boom arms and the work implement. Hydraulic cylinders powered by the engine of the machine allow for the movement of the arms and work implements. With each pivot or joint, however, a linkage pin needs to be provided to, in a manner similar to the aforementioned track-type tractor track pins, maintain the physical connections between the components while at the same time allowing for movement. Such linkage pins in turn require a continuous supply of lubrication as described above.

Over the years, a number of different configurations have been used in an attempt to provide such lubrication while preventing the loss of the lubrication and inflow of debris, e.g., dirt, dust, and moisture, into the lubrication supply. For example, it is well known, such as in US Patent Application No. 2012/0191510, assigned to the present assignee, to provide a lubrication cavity proximate such pins, with a seal assembly disposed within the lubrication cavity. The seal assembly itself can be provided in any number of different ways such as by providing a seal ring proximate to the pin, and a load ring positioned between a seal ring and the lubrication cavity so as to bias the seal ring toward the pin. The seal assembly components can be manufactured from flexible materials so as to allow a certain degree of play, but at the same time allow for direct contact between the components of the seal assembly, the lubrication cavity, and the pin, bushings, and/or spacers associated with the seal assembly.

With any of the aforementioned types of seal assemblies it is important for the load ring to maintain contact with the seal ring so as to accomplish all of the foregoing objectives, i.e., biasing the seal ring toward the pin, limiting outflow of lubricant, and preventing inflow of debris. Accordingly, seal assemblies have been developed in a number of different configurations for maintaining contact between the load ring and seal ring, such as providing splines on one or both of the load ring and seal ring. In so doing, rotational translation between the two components should be greatly reduced or avoided. However, continuous improvement in such seal assemblies is always being sought and it is desirable to provide such a seal assembly which accomplishes all the foregoing objectives, while at the same time even further limiting the movement of the load ring relative to the seal ring in all directions.

### SUMMARY OF THE DISCLOSURE

In accordance with one aspect of the disclosure, a seal assembly is therefore provided which may comprise a seal ring, a load ring in engagement with the seal ring, and a plurality of threads provided in the seal ring and the load ring and joining the seal ring and the load ring together.

In accordance with another aspect of the disclosure, an undercarriage link joint assembly is provided which may comprise a plurality of links, a pin connecting adjacent links and including first and second ends, a bushing surrounding the pin, and a seal provided at the first and second ends, the seal including a seal ring, a load ring and plurality of threads joining the seal ring and load ring together.

In accordance with yet another aspect of the disclosure, a method of assembling a seal assembly is provided which may comprise providing a seal ring, providing a load ring proximate the seal ring, and connecting the load ring to the seal ring using a plurality of threads.

These and other aspects and features of the disclosure will be more readily understood upon reading the following detailed description when taken in conjunction with the accompanying drawings.

### BRIEF DESCRIPTION OF THE DRAWINGS

FIG. 1 is a side view of a machine constructed in accordance with the present disclosure and including a plurality of track pins;

FIG. 2 is a side view of another machine constructed in accordance with the teachings of the disclosure and including a plurality of linkage pins;

FIG. 3 is a plan view of a track used on a track-type tractor such as that of FIG. 1 and showing a plurality of track links connected by a plurality of track pins;

FIG. 4 is a sectional view taken along line 4-4 of FIG. 3 and showing an undercarriage link joint assembly constructed in accordance with the teachings of this disclosure;

FIG. 5 is an enlarged view of one end of the track pin of FIG. 4 and depicting the undercarriage link joint assembly in greater detail; and

FIG. 6 is an enlarged sectional view of area 6 of FIG. 5 and showing a seal assembly constructed in accordance with the teachings of this disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

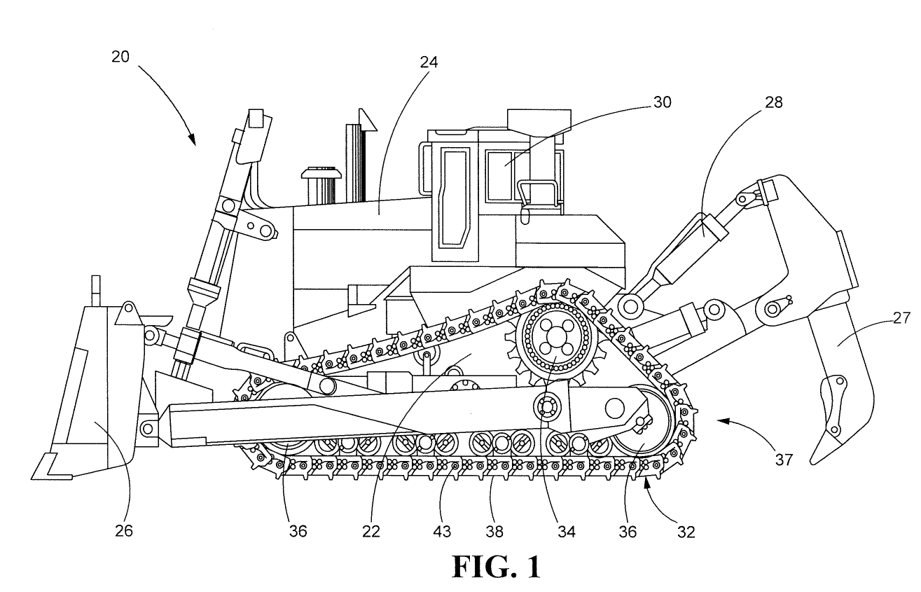

Turning now to the drawings, and with specific reference to FIG. 1, a machine constructed in accordance with the teachings of the disclosure is generally referred to by reference 20. While machine 20 is depicted as a track-type tractor having bulldozing and ripping capabilities, it is to be understood that the teachings of the disclosure are not so limited, but rather can be employed in any number of different machines including but not limited to track-type tractors, loaders (wheeled and tracked), motor graders, pipe layers, excavators, mining equipment or miners, paving equipment or pavers, and trucks.

Turning again to FIG. 1, the machine 20 is shown to include a chassis 22 on which is mounted an engine 24. Typically, the engine 24 is a diesel engine, but any number of other types of engines and prime movers including but not limited to the Otto cycle internal combustion engines and electric motors are possible. The machine 20 further includes a blade 26 for performing useful work but of course any number of other types of work implements can be so attached. Similarly, on the rear of the machine 20 it will also be noted that the machine 20 is provided with a ripper 27. As is customary, a plurality of hydraulic cylinders 28 are provided for movement of the work implements 26, 27. Finally, an operator cabin 30 is also mounted on the chassis 22, behind the engine 24, for housing the operator of the machine and enabling operation of same.

Since FIG. 1 illustrates that the machine 20 as a track-type tractor, it is depicted as employing a pair of continuous tracks 32 trained around a drive sprocket 34 and a plurality of idlers 36, all of which in combination form an undercarriage 37. As the engine 24 causes the drive sprocket 34 to rotate, the track 32 is in turn rotated around the drive sprocket 34 and the idlers 36.

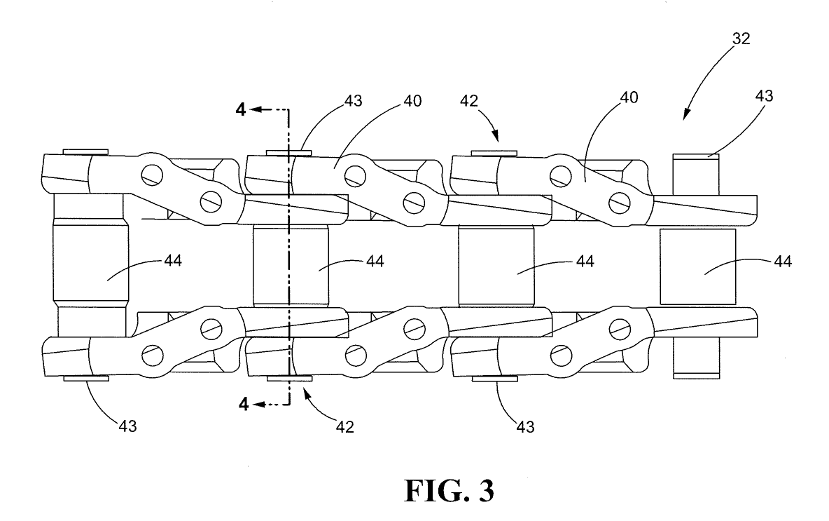

The track 32, itself, is comprised of a plurality of shoes 38 each interconnected by a plurality of track links 40 as shown best in FIG. 3. As will be noted therein, adjacent links 40 are pivotally joined together by way of a plurality of track joints 42, each including track pins 43 and bushings 44 as described in greater detail herein. It is at these track joints 42 that lubrication is needed as indicated above.

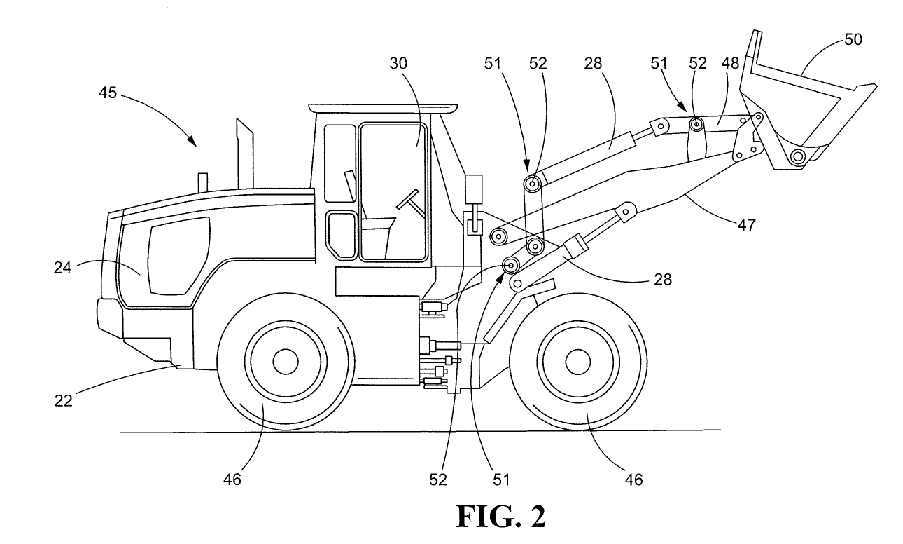

In a similar fashion, the machine 20 of FIG. 2 shows another type of pin which can advantageously employ the teachings of the present disclosure. As shown therein, the machine 20 may be a wheeled loader 45. Similar to the machine 20 of FIG. 1, the wheeled loader 45 includes chassis 22 on which is mounted engine 24 and operator cabin 30. As opposed to tracks 32, however, the wheeled loader 45 is shown including wheels 46. Of course loader 45 can also be of a tracked variety as well. The wheeled loader 45 further includes a pair of boom arms 47, to which are mounted a pair of extension arms 48, and to which are pivotally mounted a bucket 50. At the junctions 51 between each of the boom arms 47, extension arms 48 and bucket 50, it can be seen that a pin, referred to as a linkage pin 52, is provided. The linkage pin 52 is similar to the track pin 43 in that it is also in need of constant lubrication, and therefore benefits from the teachings of the present disclosure.

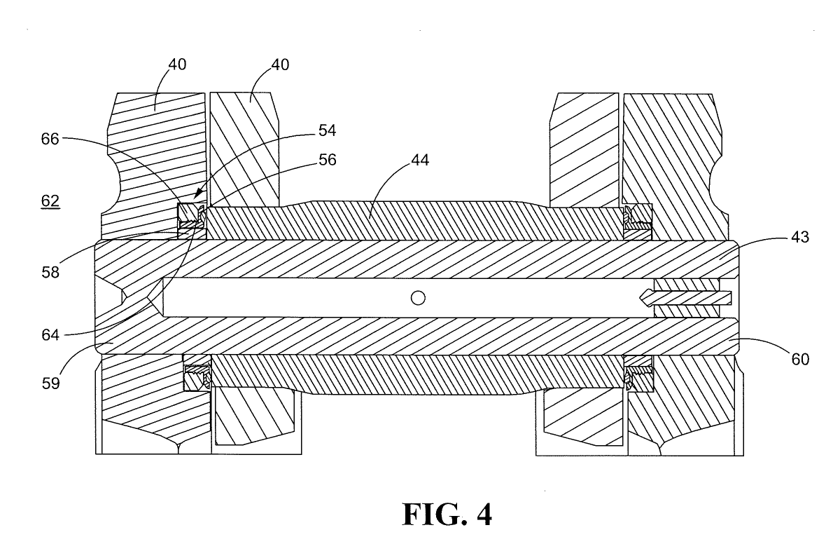

Turning to FIG. 4, an enlarged sectional view of the track links 40, track joints 42, track pin 43 and bushing 44 of FIG. 3 is depicted. Of course, it is to be understood that although a separate sectional view of the linkage pin 52 is not herein provided, a seal or seal assembly 54 according to the present disclosure can be used therewith in equal efficacy as well. As shown in FIG. 4, the seal assembly 54 is positioned within a lubrication cavity 56, itself provided within the track link 40. The track link 40 encloses two sides of the lubrication cavity 56, with a spacer 58 and the bushing 44 substantially closing off the other two sides of the lubrication cavity 56. In so doing a relatively self-enclosed lubrication cavity 56 is provided at first and second ends 59 and 60 of the track pin 43. In order to prevent outflow of lubrication (not shown but provided within the lubrication cavity 56) to the environment 62, while at the same time directing a lubricant to each of the foregoing components, the seal assembly 54 is positioned within the lubrication cavity 56. In combination, the links 40, track pin 43, bushing 44 and seal assembly 54 form an undercarriage link joint assembly 63.

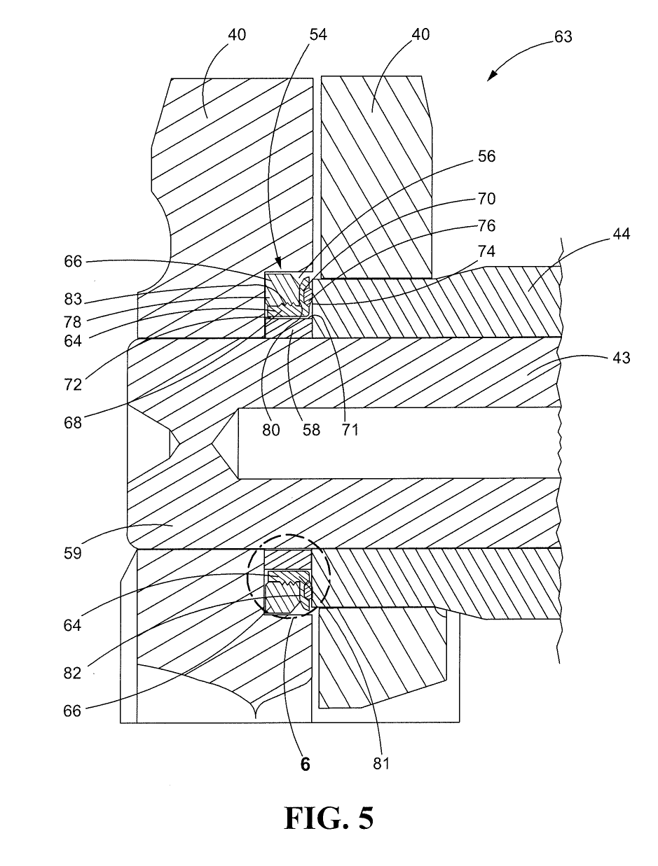

Turning now to FIG. 5, the seal assembly 54 and undercarriage link joint assembly 63 are shown in even greater detail. The seal assembly 54 includes a seal ring 64, sometimes referred to as lip seal, and load ring 66. The seal ring 64 may include an axial arm 68 as well as a radial arm 70. As will be noted, the axial arm 68 extends along an axial surface 71 of the spacer 58 with a pathway 72 provided therebetween for passage of lubricant. The radial arm 70, on the other hand, extends radially away from the axial arm 68 along a radial edge 74 of the bushing 44. In order to provide engagement between the seal assembly 54 and the bushing 44, a flexible seal lip 76 may also be provided.

As the seal ring 64 needs to be biased toward the spacer 58 and bushing 44, the load ring 66 is provided and compressed between the track link 40 and the seal ring 64. The load ring 66, may include an axial surface 78 for engagement with the axial arm 68 of the seal ring 64, as well as a radial surface 80 for engagement with the radial arm 70.

In order to provide this biasing force, while at the same time sealing the lubrication within the lubrication cavity 56 and preventing inflow of debris from the environment 62, the load ring 66 may be made of flexible material such as rubber. The seal lip 76 may be made of a similar elastomeric material such as rubber. The seal ring 64, on the other hand, may be provided with more structural rigidity and therefore may be manufactured from a core 81 of metal such as steel. In addition, in order to provide a certain degree of flexibility as well as sealability, the metal core 81 may then in turn be coated with a polymeric material 82. The specific material from which the lip seal coating 82 is manufactured will be dictated by the ultimate application of the seal assembly 54. For example, with linkage pins 52, it may be advantageous to manufacture the polymeric coating 82 from a softer polymer, whereas with the track pin 43, it may be advantageous to manufacture the polymeric coating 82 from a harder material.

In order to ensure the long term viability of the seal assembly 54, as well as its consistent ability to prevent leakage of lubricant of the lubrication cavity 56 and inflow of debris, it is important that the load ring 66 maintain constant engagement with the seal ring 64. This has proven challenging with respect to prior art efforts in this regard as constant motion of the aforementioned components, particularly in the harsh environs in which they typically operate, can cause the load ring 66 to rotate around, or axially creep or crawl along the seal ring 64. For example, over time, the load ring 66 can axially translate along the axial arm 68 of the seal ring 64 with prior art seal assemblies. However, in this regard the present disclosure drastically departs from the teachings of the prior art. It does this by providing a fixed connection between the load ring 66 and the seal ring 64 as will be described in further detail below.

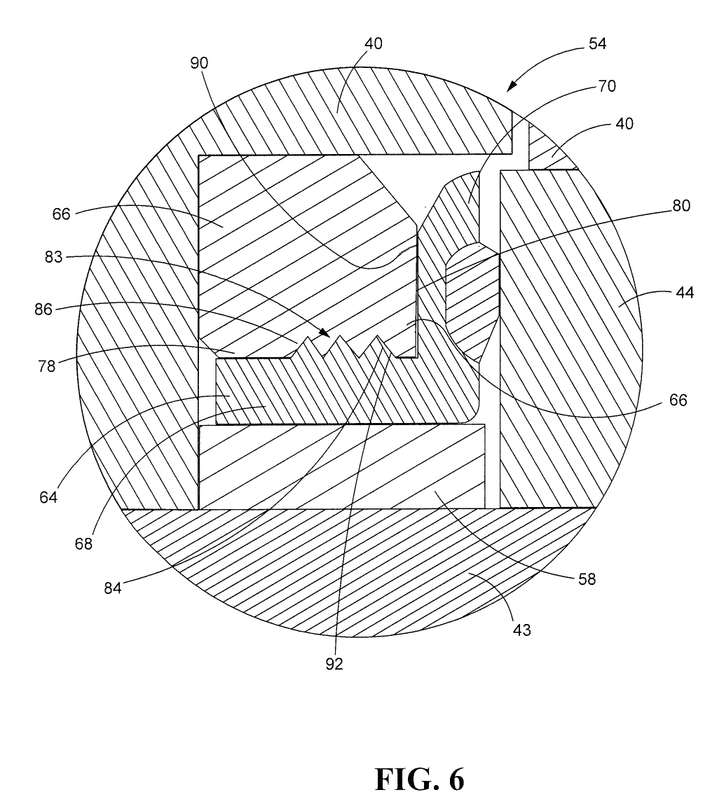

Turning now to FIG. 6, this fixed connection is shown in greater detail as being a plurality of threads 83 defined herein as helical grooves. More specifically, a first plurality of threads 84 are provided in the seal ring 64, while a second plurality of threads 86 are provided in the load ring 66. The pluralities of threads 83 through 86 are depicted in FIG. 6 as being within the axial arm 68 of the seal ring 64 and the corresponding axial surface 78 of the load ring 66, but it is to be understood that the plurality of threads 83-86 can be alternatively positioned. For example, the plurality of threads 83 may be provided in the radial arm 70 of the seal ring 64, and the associated radial surface 80 of the load ring 66 instead of, or in addition to, the axial arm 68 and associated axial surface 78.

By providing the fixed connection in the form by a plurality of threads 82, it can be seen that a labyrinthine pathway 90 is defined between the load ring 66 and seal ring 64. The labyrinthine pathway 90 includes a number of different surfaces or facets 92 at which the load ring 66 and the seal ring 64 meet and turn. This greatly inhibits the ability of the lubricant to escape to the environment 62, while at the same time also severely limiting the ability of debris from entering from the environment 62.

In addition, by fixably attaching the load ring 66 to the seal ring 64, the tendency of the load ring 66 to the rotationally move or axially translate relative to the seal ring 64, as has been an issue with respect to prior art attempts, is greatly reduced or avoided. Even though the operational forces to which the seal assembly 54 will be subjected as the machine 20 operates will tend to bias the load ring 66 in such directions, the fixedly attached load ring 66, seal ring 64 and seal assembly 54 will not allow for such movement. In turn, the load ring 66 cannot become disengaged, or less engaged, with the seal ring 64 and the operational efficacy of the seal assembly 54 is maintained throughout the operation of the machine 20.

The present disclosure does not only include the foregoing apparatus, but also sets forth a method of assembling the seal assembly 54 as well. The method may include providing the seal ring 64, providing the load ring 66 proximate to the seal ring 64, and then connecting the load ring 66 to the seal ring 64 using the plurality of threads 82.

### INDUSTRIAL APPLICABILITY

In operation, it can therefore be seen that the pending disclosure sets forth a seal assembly, an undercarriage link joint assembly, and a method of assembling a seal assembly which greatly improves upon the prior art.

More specifically, with many machines used in earth moving, agricultural, and construction applications, it is necessary to provide a constant lubrication supply to movable components of the machine such as track pins and linkage pins. The seal assembly, undercarriage link joint assembly and method of assembling a seal assembly of the present disclosure do so by fixably attaching the load ring to the seal ring using a plurality of threads.

In so doing, a labyrinthine pathway is defined between the load ring and seal ring which substantially prevents escape of the lubricant to the environment, and inflow of debris from the environment to the lubrication supply.

Moreover, it does so while at the same time substantially eliminating the ability of the load ring rotate relative to, or axially translate with respect to, the seal ring. Constant contact between the load ring and seal ring is therefore maintained and as both are housed within a lubrication cavity under compression, proper positioning of the components and sealing of the lubricant is maintained.

What is claimed is:

1. A seal assembly, comprising:
a seal ring;
a load ring in engagement with the seal ring; and
a plurality of threads provided in the seal ring and the load ring and joining the seal ring and load ring together.

2. The seal assembly of claim 1, wherein the seal ring has an axial arm and radial arm.

3. The seal assembly of claim 2, wherein the plurality of threads are provided in the axial arm.

4. The seal assembly of claim 2, wherein the plurality of threads are provided in the radial arm.

5. The seal assembly of claim 1, further including a link, a bushing and a spacer, the link, bushing, and spacer defining a lubrication cavity.

6. The seal assembly of claim 5, further including a lip seal.

7. The seal assembly of claim 1, wherein the seal ring is made of a metal base with a polymeric coating thereon, the plurality of threads being provided in the polymeric coating.

8. The seal assembly of claim 7, wherein the lip seal is made of rubber.

9. The seal assembly of claim 1, wherein the load ring is made of rubber.

10. An undercarriage link joint assembly, comprising:
a plurality of links;
a pin joining adjacent links, the pin having first and second ends;
a bushing surrounding the pin;
a seal provided at the first and second ends, the seal including a seal ring, a load ring, and a plurality of threads joining the seal ring and the load ring together.

11. The undercarriage link joint assembly of claim 10, further including a machine with which the undercarriage link joint assembly is operatively associated, the machine being one of a track-type tractor, a loader, a motor grader, a pipe layer, and excavator, a miner, a paver, and a truck.

12. The undercarriage link joint assembly of claim 10, further including a spacer, the spacer, plurality of links and bushing defining a lubrication cavity.

13. The undercarriage link joint assembly of claim 12, wherein the seal is provided in the lubrication cavity.

14. The undercarriage link joint assembly of claim 10, wherein the seal ring has an axial arm and a radial arm.

15. The undercarriage link joint assembly of claim 14, wherein the plurality of threads of the seal ring are provided in the axial arm.

16. The undercarriage link joint assembly of claim 14, wherein the plurality of threads of the seal ring are provided in the radial arm.

17. The undercarriage link joint assembly of claim 10, wherein the seal ring is manufactured from a polymeric coated metal, and the load ring is manufactured from rubber.

18. A method of assembling a seal assembly, comprising:
providing a seal ring;
providing a load ring proximate the seal ring; and
connecting the load ring to the seal ring using a plurality of threads.

19. The method of claim 18, wherein the plurality of threads forms a labyrinthine pathway preventing inflow of debris and outflow of lubricant.

20. The method of claim 19, further including providing the plurality of threads in one of a radial arm and an axial arm of the seal ring.
